(19) United States
(12) Patent Application Publication
(10) Pub. No.: US 2002/0168972 A1
(43) Pub. Date: Nov. 14, 2002

(54) Antenna feedforward interference cancellation system

(76) Inventors: James E. Justiss, Rancho Palos Verdes, CA (US); John W. Weisinger, Palos Verdes Estates, CA (US)

Correspondence Address: Kevin G. Mierzwa, Artz & Artz, P.C., Suite 250, 28333 Telegraph Road, Southfield, MI, 48034, US

(21) Appl. No.: 09/853,475

(22) Filed: May 11, 2001

(51) Int. Cl. H04Q 7/20

(52) U.S. Cl. 455/427; 455/12.1; 455/63

(57) ABSTRACT

A method of digitally canceling interference on a received signal 60 within a satellite payload 44 using an interference reference feedforward signal 62 is provided. The satellite payload 44 of the present invention receives a communication signal 54 with interference via a first antenna 52. The communication signal 54 is converted into a received signal 60 and transferred to into a first input 61a of a satellite payload circuit 61. The satellite payload circuit 61 has the first input 61a, a second input 61b, and an output 61c. The output 61c is electrically coupled to the second input 61b by a feedforward signal path 70. The satellite payload circuit 61 adaptively cancels interference on the received signal 60 using an interference reference feedforward signal 62 that is transferred from the output 61c to the second input 61b via the feedforward signal path 70.

### TECHNICAL FIELD

The present invention relates generally to interference canceling in communication satellites and transmit/receive terminals which employ digital processing and more particularly, to a method and apparatus for canceling interference on a received signal.

### BACKGROUND OF THE INVENTION

In current satellite systems there is significant interference imputed onto received communication signals due to output transmission coupling energy of the transmitted signals. The frequency spectrum that has been allocated for satellite communications has narrow separation between received signals and transmitted signals. This narrow separation between signals along with high power levels in the transmitted signals causes the interference between the transmitted signals and the received signals to be increased. The interference causes degradation in signal quality and satellite system performance.

Satellite systems often employ a digital payload, which processes received signals, switches signal paths of the received signals, and multiplexes multiple received signals to create digital transmit signals. The digital transmit signals are then converted to analog transmit signals and modulated onto transmitted carrier signals. Multiplexing and transmitting hundreds of communication signals having narrow bandwidth, which are closely spaced, also amplifies the interference created on the received signals.

Interference cancellation is used in terrestrial applications, such as, noise canceling headsets and cellular base stations. In order to accomplish interference cancellation, sensors or additional antennas are used to characterize an interference reference signal.

Now referring to FIG. 1, a terrestrial system 10 using a known method for interference cancellation in a terrestrial environment is shown. A first antenna 12 is used to receive communication signals 14 from a first source 16 such as a mobile phone. A second antenna 18 is used to receive an interference reference signal 20 from a second source 22 such as a base tower. The communication signal 14 has interference, which is approximately equal to the interference reference signal 20. The communication signal 14 is compared to the interference reference signal 20 to generate an error signal 24 by a correlator 26. The error signal 24 is transferred along with the interference reference signal 20 to a controller 28. The controller 28 adaptively cancels the interference on the communication signal 14 by transferring an interference signal 30 into a subtractor 32 to be negatively added to the communication signal 14. The controller 28 iteratively cancels the interference on the communication signal 14 until the error signal 24 is as small as possible. Notice the interference that is canceled is typically interference created from a different source other than the terrestrial system 10, which is receiving the desired signal.

Accuracy of the interference reference signal is a continuous issue in interference cancellation. The more accurate the interference reference signal the more efficient an interference cancellation system can be in removing interference from the received communication signals. Presently, interference reference signals are inaccurate in replicating the generated interference, thereby, limiting attenuation capability and narrowing cancellation bandwidths. This inaccuracy also causes decreased performance in data transfer rate and bit error rate.

Currently, to compensate for the interference, radio frequency (RF) filters are used in both receive and transmit signal paths within a satellite payload. The RF filters have mass and occupy volume in the satellite payload. Furthermore, the RF filters add signal losses to the receive and transmit signal paths. In some satellite system designs, practical limits designated for RF filter mass and volume have been reached and yet communication performance is still affected by the interference.

In satellite communication systems there is a continuing effort to reduce the mass and overall size of a satellite payload. Reducing mass and overall size decreases costs in production and implementation of satellite payloads. Furthermore, reducing satellite mass decreases cost of launch into a desired orbit.

Therefore, it is desirable to reduce the quantity and size of the components within a satellite payload while providing interference cancellation capability.

Additionally, there is a desire to increase the accuracy of the interference reference signal, thereby, increasing the performance of a satellite communication system.

### SUMMARY OF THE INVENTION

The forgoing and other advantages are provided by a method and apparatus of canceling interference on communication signals within a satellite payload. The satellite payload of the present invention receives a communication signal via a first antenna. The first antenna is electrically coupled to an analog-to-digital converter (ADC). The ADC converts the communication signal into a received signal. The ADC is coupled to a satellite payload circuit having a first input, a second input, and an output. The first input is electrically coupled to the ADC. The satellite payload circuit digitally processes the received signal to form an interference reference feedforward signal. The output is coupled to the second input by a feedforward signal path. The satellite payload circuit transfers the interference reference feedforward signal from the output to the second input via the feedforward signal path.

A method of adaptively canceling interference on a received signal within a satellite payload using an interference reference feedforward signal is also provided.

The present invention has several advantages over existing interference canceling techniques. One advantage of the present invention is that it reduces the need for RF filtering on receive and transmit signal paths in a satellite payload. The reduction in RF filtering results in reduced weight and space savings within a satellite payload. Furthermore, the reduction in RF filtering reduces costs involved in production and launch of satellite systems.

Another advantage of the present invention is that it increases performance of the satellite payload by accurately canceling the interference on the communication signals.

Therefore, a satellite payload having a minimal number of components, which can cancel interference, is possible due to the stated method advantages.

The present invention itself, together with further objects and attendant advantages, will be best understood by reference to the following detailed description, taken in conjunction with the accompanying drawing.

### BRIEF DESCRIPTION OF THE DRAWING

For a more complete understanding of this invention reference should now be had to the embodiments illustrated in greater detail in the accompanying figures and described below by way of example.

In the figures:

FIG. 1 is a block diagrammatic view of a satellite payload system using interference cancellation in a terrestrial environment.

FIG. 2 is a perspective view of a satellite communication system, utilizing a method and apparatus for canceling interference on received signals according to the present invention.

FIG. 3 is a block diagrammatic view of a satellite payload system applying interference cancellation in accordance with the present invention.

FIG. 4 is a block diagrammatic view of a satellite communication system having multiple feedback signal paths and applying interference cancellation in accordance with the present invention.

FIG. 5 is a flow chart illustrating a method, of interference cancellation for a satellite payload in accordance with the present invention.

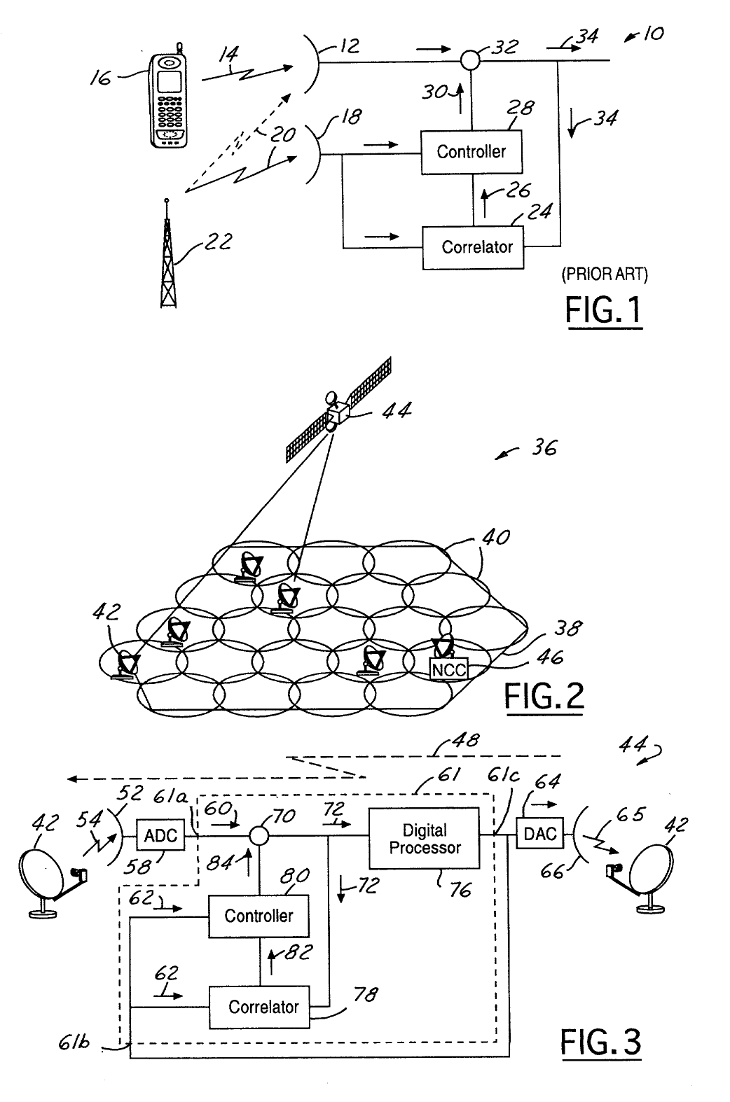

### DETAILED DESCRIPTION OF THE PREFERRED EMBODIMENT

In the following figures the same reference numerals will be used to refer to the same components. The present invention may be applied in various applications such as an X-band payload in wideband gapfiller satellites, crosslink payload systems, a crosslink payload in advanced extremely high frequency satellites, and other systems where an allocated spectrum has transmit and receive bands closely spaced and where there is a transmit/receiver system that employs digital processing.

While the present invention is described with respect to a interference cancellation apparatus and method for a satellite communication system, the following interference cancellation apparatus and method is capable of being adapted for various purposes and is not limited to the following applications: a ground based base-station, a satellite payload, a fixed satellite terminal, a mobile terminal, a mobile handset, or any other electronic or communication device having a receiver, a digital processor, and a transmitter. Also in the following description, various operating parameters and components are described for one constructed embodiment. These specific parameters and components are included as examples and are not meant to be limiting.

Referring now to FIG. 2, a satellite communication system 36 is shown including a total service geographic area 38 covered by a number of uplink and downlink spot beams having individual foot-prints 40. Uplink and downlink beams are preferably utilized to support ground based terminals 42, with high-data-rate transmission. The combination of uplink and downlink beams provides for multiple reuse of the same limited frequency spectrum by a satellite payload 44, thus creating a high-capacity satellite communication system 36 which can support numerous communication services. A network control center (NCC) 46 provides overall transmission control and uplink/downlink frequency assignment for the terminals 42 and the satellite payloads 44.

Referring now to FIG. 3, a satellite payload system 44 applying interference cancellation in accordance with the present invention is shown. The satellite payload system 44 has a first antenna 52 for receiving a communication signal 54 from a ground based terminal 42. The received communication signal 54 is transferred through an analog-to-digital converter (ADC) 58 to form a received signal 60. The received signal 60 is transferred to a first input 61a of a satellite payload circuit 61. The satellite payload circuit 61 also has a second input 61b, and an output 61c. The satellite payload circuit 61 digitally processes the received signal 60 to form an interference reference feedforward signal 62. The interference reference feedforward signal 62 is transferred through a digital-to-analog converter (DAC) 64 to form a transmit signal 65. The transmit signal 65 is transmitted by a second antenna 66 to ground based terminal 42. The interference reference feedforward signal 62 is also transferred using a feedforward signal path 70 to the second input 61b.

The satellite payload circuit 61 transfers the received signal 60 through a subtractor 70 to form a desired signal 72. The desired signal 72 is transferred to a digital processor 76 and a correlator 78. The digital processor 76 forms and transfers the interference reference feedforward signal 62 to, the DAC 64, the correlator 78, and a controller 80. The correlator 78 compares the desired signal 72 to the interference reference feedforward signal 62 to generate an error signal 82. The controller 80, based on the error signal 82, adaptively cancels the interference generated from the satellite payload 44 on the received signal 60. The controller 80 transfers a counter-interference signal 84 to the subtractor 70, which is subtracted from the received signal 60 to form the desired signal 72. Arrow 48 illustrates interference imputed onto the communication signal 54 from the transmitted signal 65.

The digital processor 76 may perform several functions. The digital processor 76 may perform as a digital sample transponder or may perform packet switching through demodulation and rerouting of signals. The high power levels of the generated transmit signals 65 created within the digital processor 76 cause interference on the communication signals 54. In addition to the high power level of the transmit signals 65, a narrow frequency separation between the received communication signals 54 and the transmit signals 65 also causes interference. The digital processor 76 transfers an interference reference feedforward signal 62 to the correlator 78 and the controller 80. By digitally transferring the interference reference feedforward signal 62 to the correlator 78 and the controller 80 the satellite payload 44 has the ability to accurately decipher the generated interference from the communication signal 54. This feedforward design also allows for accurate timing of signals having various frequencies and bandwidth.

The correlator 78 compares the interference reference feedforward signal 62 to the desired signal 72 to generate an error signal 82. If the frequencies and amplitudes of the interference reference feedforward signal 62 correspond to the frequencies and amplitudes of the desired signal 72 then the error signal 82 is small. The error signal 82 may be a stream of digital data points have varying amplitude, phase, and frequency. The error signal 82 may also be as simple as a magnitude value representing a level of error.

The controller 80 adaptively cancels the interference on the received signal 60 based on the error signal 82. By using the interference reference feedforward signal 62 the controller 80 is able to better attenuate and cancel the interference. The controller 80 iteratively cancels the interference until the error signal 82 is as small as possible. The controller 80 transfers the counter-interference signal 84 to the subtractor 70, which in turn adds the received signal 60 to the negative of the counter-interference signal 84 to create the desired signal 72.

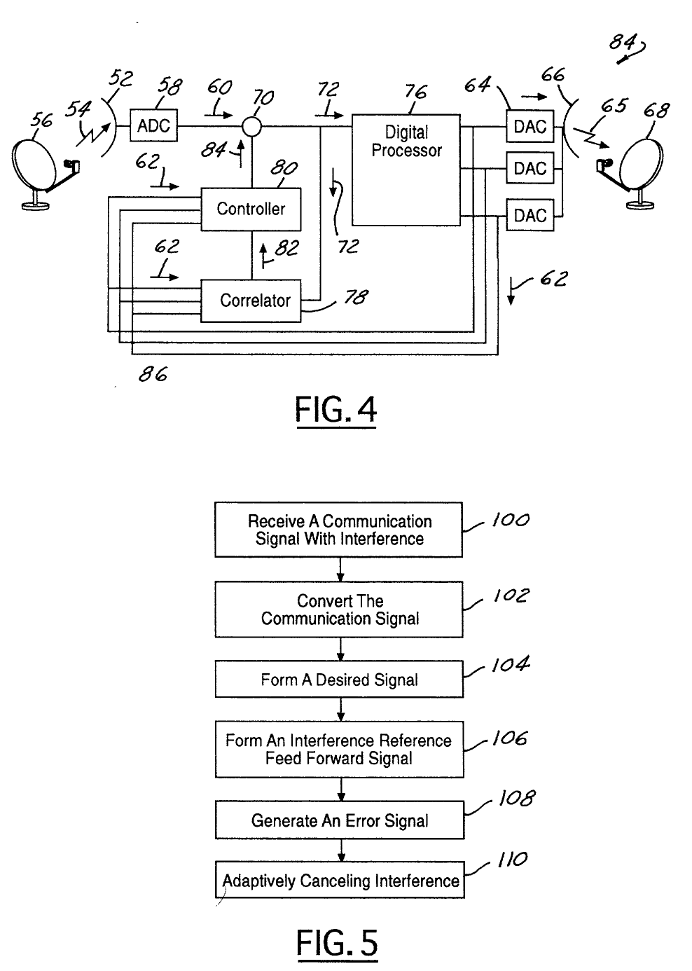

Referring now to FIG. 4, a satellite payload 84, having multiple feedback signal paths 86, applying interference cancellation in accordance with the present invention is shown. The satellite payload 84 of the present invention is capable receiving and transmitting multiple communication signals. The digital processor 76, the correlator 78, and the controller 80 of the present invention are capable of transferring multiple communication signals simultaneously or sequentially. A system internal clock may be used for timing of the multiple signals. The satellite payload 84 is similar to the satellite payload 44, in FIG. 3, except multiple feedforward paths 86 and multiple DACs 64 are used to accommodate for multiple signal reception and transmission. Also, although not shown, multiple ADCs 58 and subtractors 70 may be used to accommodate for multiple communication signals.

Referring now also to FIG. 5, a flow chart illustrating a method, of interference cancellation for a satellite payload in accordance with the present invention is shown. Although the following describes a method of removing interference created from within the satellite payload 44 the present invention may be applied to remove interference generated from another source separate from the satellite payload 44.

In step 100, the satellite payload receives communication signals 54 with interference through the use of the first antenna 52.

In step 102, the ADC 58 converts the received communication signals 54 into received signals 60.

In step 104, the counter-interference signals 84 are subtracted from the received signals 60 to form the desired signals 72.

In step 106, the desired signals 72 are digitally processed to form the interference reference feedforward signals 62.

In step 108, the correlator 78 compares the interference reference feedforward signals 62 to the desired signals 64 and generates the error signals 82.

In step 110, the controller 80 adaptively cancels the interference on the received signals 60. The controller 80 generates and transfers the counter-interference signals 84 based on the error signals 82 to the subtractor 70 to cancel the interference on the received signal 60.

The above-described invention, by digitally providing an interference reference feedforward signal to the correlator and controller, accurately eliminates the interference from the received communication signals. The present invention reduces the need for filtering to remove interference. The reduction in the amount of satellite payload components reduces satellite payload mass, increases available space on the satellite payload, and saves on production and launch costs.

The above-described interference canceling method, to one skilled in the art, is capable of being adapted for various purposes and is not limited to the following applications: X-band payload on wideband gapfiller satellites, crosslink payload on advanced extremely high frequency satellites, and other systems where the allocated spectrum has transmit and receive bands closely spaced and which have digital processing payloads. The above-described invention may also be varied without deviating from the true scope of the invention.

What is claimed is:

1. A method of digitally canceling interference on a received signal within a satellite payload comprising adaptively canceling interference on the received signal using an interference reference feedforward signal.

2. A method as in claim 1 further comprising subtracting an counter-interference signal from the received signal to form a desired signal.

3. A method as in claim 2 further comprising digitally processing said desired signal to generate said feedforward interference reference signal.

4. A method as in claim 3 further comprising correlating said interference reference feedforward signal to said desired signal to generate an error signal.

5. A method as in claim 4 wherein adaptively canceling interference on the received signal farther comprising generating said counter-interference signal based on said error signal to cancel said interference.

6. A method as in claim 5 wherein adaptively canceling interference further comprises iteratively canceling interference on the received signal until said error signal equals zero.

7. A method as in claim 1 wherein said adaptively canceling interference farther comprises digitally and accurately replicating the interference.

8. A method as in claim 1 further comprising simultaneously digitally canceling interference on a plurality of received signals.

9. A method as in claim 1 further comprising sequentially digitally canceling interference on a plurality of received signals.

10. A method of digitally canceling interference on a received signal within a satellite payload comprising:
receiving a communication signal having interference; converting said communication signal into the received signal;
subtracting a counter-interference signal from the received signal to form a desired signal;
digitally processing said desired signal to form an interference reference feedforward signal;
correlating said interference reference feedforward signal to said desired signal to generate an error signal; and
adaptively canceling interference on the received signal based on said error signal by generating said counter-interference signal to cancel said interference.

11. A satellite communication system comprising:
a first antenna for receiving a communication signal;
an analog-to-digital converter (ADC) electrically coupled to said first antenna, said ADC converting said communication signal to a received signal;
a satellite payload circuit comprising a first input, a second input, and an output, said first input is electrically coupled to said ADC;
said satellite payload circuit digitally processing said received signal to form an interference reference feedforward signal; and
a feedforward signal path electrically coupling said output to said second input, said feedforward signal path transferring said interference reference feedforward signal from said output to said second input.

12. A system as in claim 11 wherein said satellite payload circuit further comprises:
a subtractor electrically coupled to said ADC, said subtractor subtracting a counter-interference signal from said received signal to form a desired signal;
a digital processor electrically coupled to said subtractor, said digital processor generating said interference reference feedforward signal from said desired signal;
a correlator electrically coupled to said subtractor, said correlator comparing said interference reference feedforward signal to said desired signal to generate an error signal; and
a controller electrically coupled to said correlator and said subtractor, said controller adaptively canceling interference on said received signal based on said error signal.

13. A communication system comprising:
a first antenna for receiving a communication signal;
an analog-to-digital converter (ADC) electrically coupled to said first antenna, said ADC converting said communication signal to a received signal;
a subtractor electrically coupled to said ADC, said subtractor subtracting a counter-interference signal from said received signal to form a desired signal;
a digital processor electrically coupled to said subtractor, said digital processor generating said interference reference feedforward signal from said desired signal;
a correlator electrically coupled to said subtractor, said correlator comparing said interference reference feedforward signal to said desired signal to generate an error signal; and
a controller electrically coupled to said correlator and said subtractor, said controller adaptively canceling interference on said received signal based on said error signal.
